(19) United States
(12) Patent Application Publication
(10) Pub. No.: US 2017/0050801 A1
(43) Pub. Date: Feb. 23, 2017

(54) WASTE AND WATER TANK

(71) Applicant: RAMPF Composite Solutions Inc., Burlington (CA)

(72) Inventors: Gerry KAVANAUGH, Burlington (CA); Joerg Wiebe, Ft. Myers, FL (US)

(73) Assignee: RAMPF Composite Solutions Inc., Burlington, ON (CA)

(21) Appl. No.: 15/307,222

(22) PCT Filed: Apr. 30, 2015
(86) PCT No.: PCT/CA2015/000288

§ 371 Date: Oct. 27, 2016

Related U.S. Application Data
(60) Provisional application No. 61/987,059, filed on May 1, 2014.
(60) Provisional application No. 62/111,784, filed on Feb. 4, 2015.

(51) Int. Cl. B65D 90/04; B29C 65/00; B29C 70/54; B29C 70/70; B29C 70/48; B29C 70/06

(52) U.S. Cl. CPC B65D 90/046; B29C 70/48; B29C 70/06; B29C 70/54; B29C 70/70; B29C 66/727; B29L 2031/7154

(57) ABSTRACT

A storage tank for storing water, waste, or other material is provided where the storage tank has co-moulded external features for fittings. A method for manufacturing such a storage tank is also provided.

### TECHNICAL FIELD

The present disclosure relates to storage tanks, particularly, storage tanks for waste, water, or other material.

### BACKGROUND

Storage tanks for water, waste, or other material, once installed in certain applications such as aircraft or modern trains, are not expected to be removed or otherwise repaired. These waste storage tanks may contain significant biological waste and must withstand chemical activity. Although not necessarily subject to the same chemical activity, the water tanks like the waste storage tanks are connected through pipes and may be installed on legs. Accordingly, it is desirable for these storage tanks to have a construction that limits potential leak paths and holds a significant volume of material all while maintaining a reduced weight.

Presently, the standard manufacturing process for storage tanks for applications such as aircraft involves using a collapsible silicone mandrel for tooling to which an interfacing layer is applied. The interfacing layer is wrapped with carbon fibre and cured. To wrap the interfacing layer, double-ended threaded connections are used to rotate the liner on mandrel support. This not only leaves end-caps on the storage tanks, but also provides a blank pressure vessel with no features. Holes are then cut, and fittings and other features are later bonded to the surface of the tank. Tightly wound filament while reducing gaps and leak paths can increase the weight of the product. Loosely wound filament, while reducing weight, can result in gaps and leak paths in the completed tank. Accordingly, it is desirable to create a storage tank that may be of lower weight, lower cost, and/or have reduced leak paths.

### SUMMARY

According to one aspect of the present disclosure, a method of manufacturing a storage tank for storing waste, water, or other liquid, where the storage tank has external features for fittings is provided. The method comprises providing a pre-formed liner defining a vessel wherein the pre-formed liner functions as an inner layer for the tank. Dry reinforcing fibre is applied on the pre-formed liner, and a shell having at least one insert is placed around the pre-formed liner for layering the reinforcing fibre on the pre-formed liner. Liquid resin is drawn into the shell under vacuum for saturating the fibre. Finally, the shell is removed to reveal a tank having at least one co-moulded external feature corresponding to the at least one insert.

In another aspect of the present disclosure, a method of manufacturing a storage tank for storing waste, water, or other liquid, where the storage tank has external features for fittings is provided. The method comprises providing a pre-formed liner defining a vessel wherein the pre-formed liner functions as an inner layer for the tank. Resin pre-impregnated reinforcing fibre is applied on the pre-formed liner, and a shell having at least one insert is placed around the pre-formed liner for layering the resin pre-impregnated reinforcing fibre on the pre-formed liner. The shell is then removed to reveal a tank having at least one co-moulded external feature corresponding to the at least one insert.

In another aspect of the present disclosure, a storage tank for storing waste, water, or liquid, where the storage tank has component layers and external features for fittings is also provided. The storage tank comprises an inner layer, an outer fibre layer, and fittings integral with the storage tank.

### BRIEF DESCRIPTION OF THE DRAWINGS

These and other features will become more apparent from the following description in which reference is made to the appended drawings wherein:

FIG. 1 shows a method of manufacturing a storage tank having external features in accordance with an embodiment of the present disclosure;

FIG. 2 shows an exemplary storage tank with external features; and

FIG. 3 shows a cutaway view of the storage tank of FIG. 2.

### DETAILED DESCRIPTION

One or more currently preferred embodiments have been described by way of example.

One aspect of the present disclosure provides a method of manufacturing a storage tank for storing waste, water, or other material, where the storage tank has external features for fittings. The storage tank, indicated generally by the reference numeral 100 in the accompanying figures, is formed by providing a pre-formed liner 102 defining a vessel 104, and can be manufactured by injection moulding, blow moulding, rotational moulding, or other methods known to one skilled in the art. The vessel 104 is shown as cylindrical in the accompanying drawings but may take on any suitable shape capable of holding a volume. The pre-formed liner 102 acts as the inner layer 106 for the storage tank 100 as well as the support layer for additional layers described below. In this way, the pre-formed liner 102 need not be later dissolved or extracted but remains as an inner layer 106 of the storage tank 100.

For storage tanks intended to store hazardous or waste material, the pre-formed liner 102 or inner layer 106 may limit the build-up of bio-film either inherently or through the use of additives and may generally resist the chemical activity of the material stored in the storage tank 100. For example, the pre-formed liner 102 may be a thermoplastic layer that resists various industrial chemicals and solvents as well as provides resistance to bio-film build-up. This resistance also limits breach by various chemical compositions that could be held in the storage tank 100. Examples of thermoplastics that may be used as the pre-formed liner 102 and inner layer 106 include fluoropolymers that are thermoformable such as polytetrafluoroethylene (PTFE), fluorinated ethylene propylene (FEP), perfluoroalkoxy (PFA), polyvinylidene fluoride (PVDF), ethylene tetrafluoroethylene (ETFE), and ethylene fluorinated ethylene propylene (EFEP) among others. The inner layer 106 may additionally be polyamide (nylon), acrylonitrile butadiene styrene (ABS) or combinations thereof. Such combinations could be co-extruded or otherwise formed. Other examples include polyvinyl chloride (PVC), chlorinated polyvinyl chloride (CPVC), high density polyethylene (HDPE), or other materials known to one skilled in the art. The inner layer 106 may also be a thermoset plastic layer, such as polyether ether ketone (PEEK), polyetherimide (PEI), or cross-linked polyethylene (PEX), among others including suitable combinations thereof known to one skilled in the art.

For storage tanks intended to store water or other liquid or material intended for ingestion, cleaning, or the like, the pre-formed liner 102 functioning as the inner layer 106 may be comprised of a food grade material, for example, a food grade thermoplastic or thermoset such a polyethylene terephthalate (PETG) or other as will be known to one skilled in the art.

Following the provision of a pre-formed liner 102, dry reinforcing fibre 116 is applied on the pre-formed liner 102, and a shell 110 having at least one insert 112 is placed around the pre-formed liner 102 for layering the reinforcing fibre 116 on the pre-formed liner 102. The reinforcing fibre 116 may be applied directly on the pre-formed liner 102. Alternatively, or in addition, the reinforcing fibre 116 may be pre-loaded into the shell 110 prior to placing the shell 110 around the pre-formed liner 102. The reinforcing fibre 116 may be carbon, glass, Kevlar® or any other suitable reinforcing fibre as will be known to one skilled in the art. This reinforcement may impart mechanical strength and permit the storage tank 100 to withstand temperature fluctuations among other desirable properties.

Optionally, a foam core may be incorporated into the reinforcing fibre 116 to create, for example a carbon fibre foam core laminate that limits buckling. The reinforcing fibres 116 may be woven materials, unidirectional, tailored fibre placement pre-forms, braided materials, or in any other suitable form known to one skilled in the art.

Liquid resin is then drawn into the shell 110 under vacuum for saturating the reinforcing fibre 116. The resin may be epoxy resin or another thermoset or thermoplastic polymer as known to one skilled in the art to bind the reinforcing fibre 116. The liquid resin may then be cured by the application of heat, pressure, or other suitable curing means as will be known to one skilled in the art. As known to one skilled in the art, curing the liquid resin may impart improved mechanical properties such as increased strength and hardness.

The shell 110 is then removed to reveal a tank 100 having at least one co-moulded external feature 118 corresponding to the number of inserts 112 included in the shell 110. Advantageously, the storage tank 100 revealed has no undesirable end-caps that would otherwise be present if the tank were filament wound.

In an alternative embodiment, a resin pre-impregnated reinforcing fibre is applied on the pre-formed liner 102 rather than a dry reinforcing fibre 116. The application of resin pre-impregnated reinforcing fibre on the preformed liner 102 bypasses the need to draw liquid resin into the shell 110 under vacuum for saturating the reinforcing fibre 116. The resin pre-impregnated reinforcing fibre may be any of the reinforcing fibres described above such as carbon, glass, Kevlar®, or any other suitable reinforcing fibre. Accordingly, it may be pre-impregnated with epoxy resin, another thermoset or thermoplastic polymer or any other suitable resin as will be known to one skilled in the art.

The shell 110 described above having the at least one insert 112 is placed around the pre-formed liner 102 for layering the resin pre-impregnated reinforcing fibre on the pre-formed liner 102. As is the case with the reinforcing fibre 116, the resin pre-impregnated reinforcing fibre may be applied directly on the pre-formed liner 102. Alternatively, or in addition, the pre-impregnated reinforcing fibre may be pre-loaded into the shell 110 prior to placing the shell 110 around the pre-formed liner 102.

The pre-impregnated reinforcing fibre may then be cured by the application of pressure, heat, or other suitable curing means as will be known to one skilled in the art.

Exposure to heat or pressure activates the catalyst in the resin to cross-link the polymers to impart improved mechanical properties such as increased strength.

Optionally, a foam core may be incorporated into the impregnated reinforcing fibre to create, for example a carbon fibre foam core laminate that limits buckling as described above.

The shell 110 is then removed to reveal a tank 100 having the co-moulded external features 118 corresponding to the number of inserts 112 included in the shell 110. Holes 120 may then be formed in the external features 118, for example, by drilling, as needed for connection points.

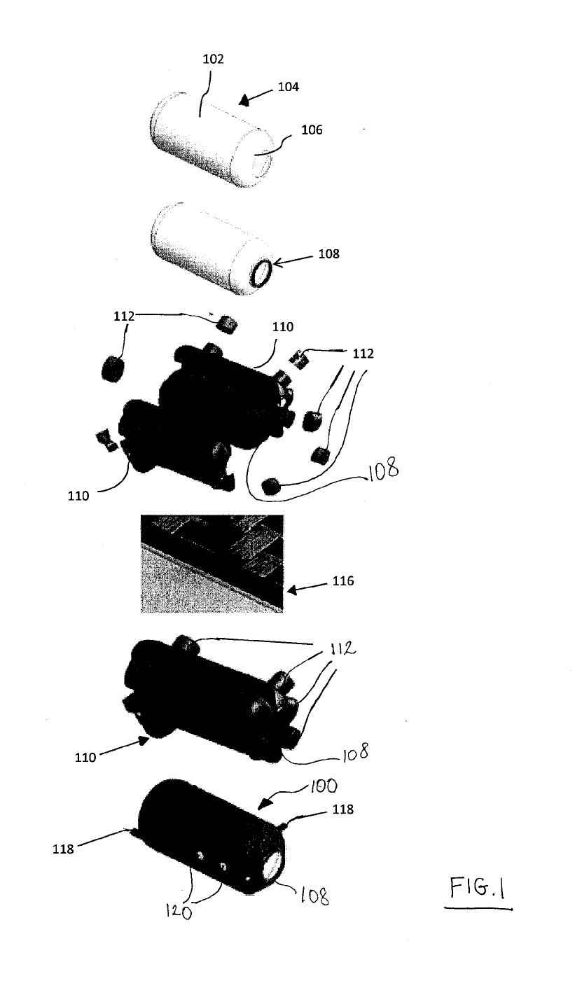

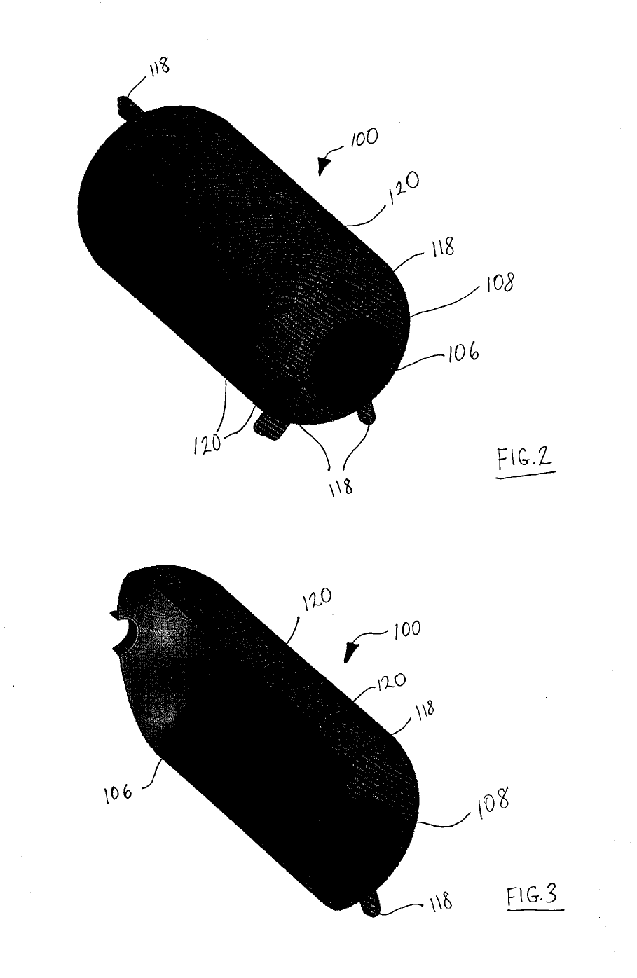

Advantageously, the storage tank 100 revealed has no undesirable end-caps that would otherwise be present if the tank were filament wound. However, to allow for connection points, for example, where a separator may attach or for a clearing access path, a polar end flange 108 may be formed on the storage tank 100. In one embodiment, the polar end flange 108 may be added on the pre-formed liner 102 prior to the application of the dry reinforcing fibre 116 or resin pre-impregnated reinforcing fibre as shown in FIG. 1. The shell 110 would have a corresponding allowance for the polar end flange 108 as shown in FIG. 1.

Another aspect of the present disclosure provides a storage tank for storing waste, water, or other material. The storage tank 100 has an inner layer 106 as described above, an outer reinforcing fibre layer 116 as described above, and fittings 118 integral with the storage tank 100. These integral fittings limit the number of leak paths in the storage tank 100.

It will be apparent to persons skilled in the art that a number of variations and modifications can be made without departing from the scope of the claims.
100 storage tank
102 pre-formed inner liner
104 vessel
106 inner layer
108 polar end flange
110 shell
112 inserts
116 reinforcing fibre
118 external features
120 holes

What is claimed is:

1. A method of manufacturing a storage tank for storing waste, water, or material, the storage tank having external features for fittings, the method comprising:
providing a pre-formed liner defining a vessel wherein said pre-formed liner functions as an inner layer for said tank;
applying dry reinforcing fibre on said pre-formed liner;
placing a shell having at least one insert around said pre-formed liner for layering said reinforcing fibre on said pre-formed liner;
drawing liquid resin into said shell under vacuum for saturating said reinforcing fibre; and
removing said shell to reveal a tank having at least one co-moulded external feature corresponding to said at least one insert.

2. The method of manufacturing a storage tank of claim 1, further comprising loading said dry reinforcing fibre into said shell and at least one insert prior to placing said shell around said pre-formed liner.

3. The method of manufacturing a storage tank of claim 1, further comprising curing said liquid resin for improving mechanical strength.

4. The method of manufacturing a storage tank of claim 1, wherein said pre-formed liner comprises a food-grade material for storing water in the storage tank.

5. The method of manufacturing a storage tank of claim 1, wherein said pre-formed liner comprises a material resistant to at least one waste system chemical for resisting bio-film build-up of material stored in the storage tank.

6. The method of claim 1, further comprising adding a foam core into the fibre laminate to limit buckling.

7. A method of manufacturing a storage tank for storing waste, water, or material, the storage tank having external features for fittings, the method comprising:
providing a pre-formed liner defining a vessel wherein said pre-formed liner functions as an inner layer for said tank;
applying resin pre-impregnated reinforcing fibre on said pre-formed liner;
placing a shell having at least one insert around said pre-formed liner for layering said resin pre-impregnated reinforcing fibre on said pre-formed liner; and
removing said shell to reveal a tank having at least one co-moulded external feature corresponding to said at least one insert.

8. The method of manufacturing a storage tank of claim 7, further comprising loading said resin pre-impregnated reinforcing fibre into said shell and at least one insert prior to placing said shell around said pre-formed liner.

9. The method of manufacturing a storage tank of claim 1, further comprising curing said pre-impregnated reinforcing fibre for improving mechanical strength.

10. The method of manufacturing a storage tank of claim 7, wherein said pre-formed liner comprises a food-grade material for storing water in the storage tank.

11. The method of manufacturing a storage tank of claim 7, wherein said pre-formed liner comprises a material resistant to at least one waste system chemical for resisting bio-film build-up of material stored in the storage tank.

12. The method of claim 7, further comprising adding a foam core into the fibre laminate to limit buckling.

13. A storage tank for storing waste, water, or material, the storage tank having component layers and external features for fittings, the storage tank comprising:
an inner layer;
an outer reinforcing fibre layer; and
fittings integral with the storage tank;

14. The storage tank of claim 13, further comprising a foam core incorporated in the fibre composite layer for limiting buckling.

15. The storage tank of claim 13, wherein the inner layer is a thermoplastic liner.

16. The storage tank of claim 14, wherein the thermoplastic liner is selected from the group consisting of: polytetrafluoroethylene (PTFE), fluorinated ethylene propylene (FEP), perfluoroalkoxy (PFA), polyvinylidene fluoride (PVDF), ethylene tetrafluoroethylene (ETFE), ethylene fluorinated ethylene propylene (EFEP), high density polyethylene (HDPE), or a combination thereof.

17. The storage tank of claim 13, wherein the inner layer is a thermoset plastic liner.

18. The storage tank of claim 17, wherein the thermoset plastic liner is selected from the group consisting of: polyether ether ketone (PEEK), polyetherimide (PEI), cross-linked polyethylene (PEX), or a combination thereof.
